(19) United States
(12) Patent Application Publication
(10) Pub. No.: US 2009/0058870 A1
(43) Pub. Date: Mar. 5, 2009

(54) DISPLAY DEVICE AND ERROR DIFFUSION METHOD THEREFOR

(76) Inventor: Masanori Takeuchi, Miyazaki (JP)

Correspondence Address: MCDERMOTT WILL & EMERY LLP, 600 13TH STREET, N.W., WASHINGTON, DC, 20005-3096, US

(21) Appl. No.: 12/295,029

(22) PCT Filed: Apr. 21, 2006
(86) PCT No.: PCT/JP2006/308447

§ 371 Date: Oct. 29, 2008

(51) Int. Cl. G09G 5/00

(52) U.S. Cl. 345/581; 345/214

(57) ABSTRACT

A display device is provided which includes: a decimal part conversion unit (302) which converts a value of a decimal part of a pixel signal for a target pixel into another value when the decimal part takes a specific value, the pixel signal having an integer part and the decimal part; an error addition unit (301) which distributes and adds a difference between the decimal part before the conversion and the decimal part after the conversion to signals for a plurality of pixels adjacent to the target pixel; and an error diffusion unit (311) which performs addition based on a pixel signal for the target pixel composed of the decimal part after the conversion and the integer part and decimal parts of the signals for the plurality of pixels adjacent to the target pixel, and outputs an integer part after the addition as a pixel signal for the target pixel.

### TECHNICAL FIELD

The present invention relates to a display device and an error diffusion method therefor.

### BACKGROUND ART

Gradations of a display device using the subfield method are expressed by gradations (real gradations) by combination (lighting pattern) of ON/OFF of subfields and by gradations (diffusion gradations) expressed in a false manner by mixing two adjacent real gradations at a predetermined ratio. Generally, the diffusion gradations are embodied by error diffusion processing.

The case where the same gradation is displayed over a certain area as shown in FIG. 10 encounters a problem of a figure pattern occurring due to the error diffusion processing, which significantly deteriorates the image quality.

A drive unit for a plasma display panel in the following Patent Document 1 comprises: a means which verifies whether or not an input gradation value can be displayed; a means which calculates an error value between the gradation value and a gradation value adjacent to the former gradation value when the input gradation value cannot be displayed; a means which diffuses the error value to a pixel adjacent thereto; a means which multiplies the error value outputted from each diffusion means by each coefficient value; a means which adds the multiplied values; a means which adds the added value and a next input gradation value; and a random value generation means which generates a random value to be supplied to the multiplier, wherein the random value is used to change the coefficient value on a random basis to prevent occurrence of noise in the figure pattern so as to improve the image quality.

Since a complete random value cannot be generated, however, it is difficult to suppress the occurrence of the figure pattern when the area where the same gradation is displayed is increased. Further, at a specific gradation, there also occurs a phenomenon that only one of the gradations is displayed at the upper left corner of the screen.

Patent Document 1: Japanese Patent Application Laid-open No. 2004-272253

### SUMMARY OF THE INVENTION

An object of the present invention is to provide a display device capable of suppressing a noise in a figure pattern caused by error diffusion to improve the image quality, and an error diffusion method therefor.

A display device of the present invention includes: a decimal part conversion unit which converts a value of a decimal part of a pixel signal for a target pixel into another value when the decimal part takes a specific value, the pixel signal having an integer part and the decimal part; an error addition unit which distributes and adds a difference between the decimal part before the conversion and the decimal part after the conversion to signals for a plurality of pixels adjacent to the target pixel; and an error diffusion unit which performs addition based on a pixel signal for the target pixel composed of the decimal part after the conversion and the integer part and decimal parts of the signals for the plurality of pixels adjacent to the target pixel, and outputs an integer part after the addition as a pixel signal for the target pixel.

Further, an error diffusion method for a display device of the present invention includes: a decimal part conversion step of converting a value of a decimal part of a pixel signal for a target pixel into another value when the decimal part takes a specific value, the pixel signal having an integer part and the decimal part; an error addition step of distributing and adding a difference between the decimal part before the conversion and the decimal part after the conversion to signals for a plurality of pixels adjacent to the target pixel; and an error diffusion step of performing addition based on a pixel signal for the target pixel composed of the decimal part after the conversion and the integer part and decimal parts of the signals for the plurality of pixels adjacent to the target pixel, and outputting an integer part after the addition as a pixel signal for the target pixel.

### BRIEF DESCRIPTION OF THE DRAWINGS

FIG. 1 is a diagram showing a configuration example of a plasma display device according to a first embodiment of the present invention;

FIG. 2 is an exploded perspective view showing a configuration example of the plasma display panel;

FIG. 3 is a diagram showing a configuration of one field of an image;

FIG. 4 is a block diagram showing a configuration example of an error diffusion circuit;

FIG. 5 is a diagram showing an example of conversion by a decimal conversion circuit;

FIG. 6 is a diagram showing an example of conversion by the decimal conversion circuit;

FIG. 7 is an illustration for explaining error diffusion processing by the error diffusion circuit;

FIG. 8 is a block diagram showing a configuration example of an error diffusion circuit according to a second embodiment of the present invention;

FIG. 9 is a diagram showing a configuration example of a plasma display device according to a third embodiment of the present invention;

FIG. 10 is a view showing a figure pattern occurring in an image when normal error diffusion processing is performed on a flat portion of an image having the same gradation value; and

FIG. 11 is a view showing an image when the error diffusion processing according to the first embodiment is performed on the flat portion of the image having the same gradation value.

### DETAILED DESCRIPTION OF THE PREFERRED EMBODIMENTS

### First Embodiment

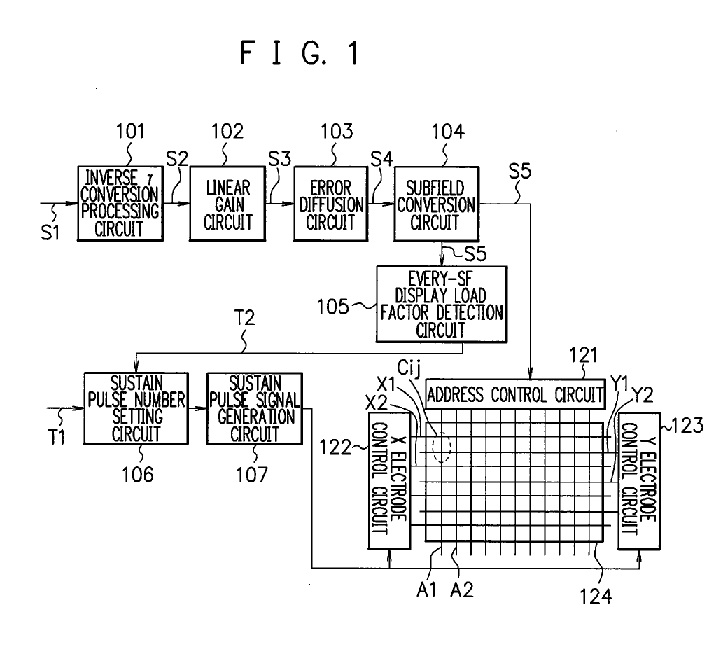

FIG. 1 is a diagram showing a configuration example of a plasma display device (a display device) according to a first embodiment of the present invention.

An X electrode control circuit 122 supplies a predetermined voltage to X electrodes X1, X2, and so on. Hereinafter, each of the X electrodes X1, X2, and so on or their generic name is referred to as an X electrode Xi, i representing a suffix.

A Y electrode control circuit 123 supplies a predetermined voltage to Y electrodes Y1, Y2, and so on. Hereinafter, each of the Y electrodes Y1, Y2, and so on or their generic name is referred to as a Y electrode Yi, i representing a suffix.

An address control circuit 121 supplies a predetermined voltage to address electrodes A1, A2, and so on. Hereinafter, each of the address electrodes A1, A2, and so on or their generic name is referred to as an address electrode Aj, j representing a suffix.

In a plasma display panel 124, the Y electrodes Yi and the X electrodes Xi form rows extending in parallel in the horizontal direction, and the address electrodes Aj form columns extending in the vertical direction. The Y electrodes Yi and the X electrodes Xi are alternately arranged in the vertical direction.

The Y electrodes Yi and the address electrodes Aj form a two-dimensional matrix with i rows and j columns. A display cell Cij is formed of an intersection of the Y electrode Yi and the address electrode Aj, and the X electrode Xi adjacent corresponding to it. This display cell Cij corresponds to a pixel so that the plasma display panel 124 can display a two-dimensional image.

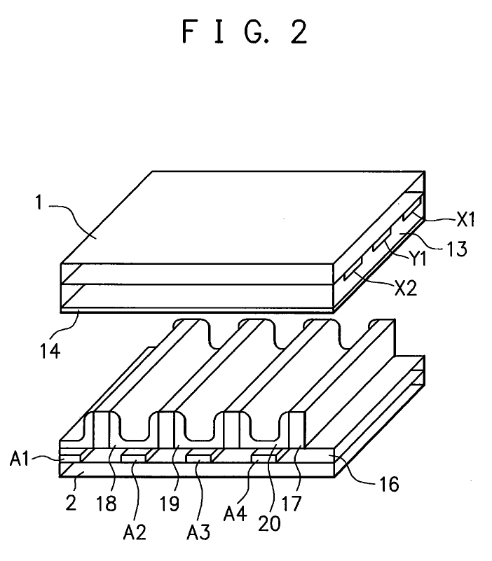

FIG. 2 is an exploded perspective view showing a configuration example of the plasma display panel 124. The X electrodes Xi and the Y electrodes Yi are formed on a front glass substrate 1. Over the X electrodes Xi and the Y electrodes and the front glass substrate 1, a dielectric layer 13 is deposited for insulation against a discharge space. Over the dielectric layer 13, a MgO (magnesium oxide) protective film 14 is further deposited.

On the other hand, the address electrodes Aj are formed on a rear glass substrate 2 which is disposed opposite the front glass substrate 1. Over the address electrodes Aj and the rear glass substrate 2, a dielectric layer 16 is deposited. Over the dielectric layer 16, phosphor layers 18 to 20 are further deposited. On inner surfaces of partition walls (ribs) 17, the red, blue, and green phosphor layers 18 to 20 are arranged and applied in stripes for each color. Discharges between the X electrodes Xi and the Y electrodes Yi excite the phosphor layers 18 to 20 to emit lights in respective colors. A Ne—Xe Penning gas or the like is filled in the discharge space between the front glass substrate 1 and the rear glass substrate 2.

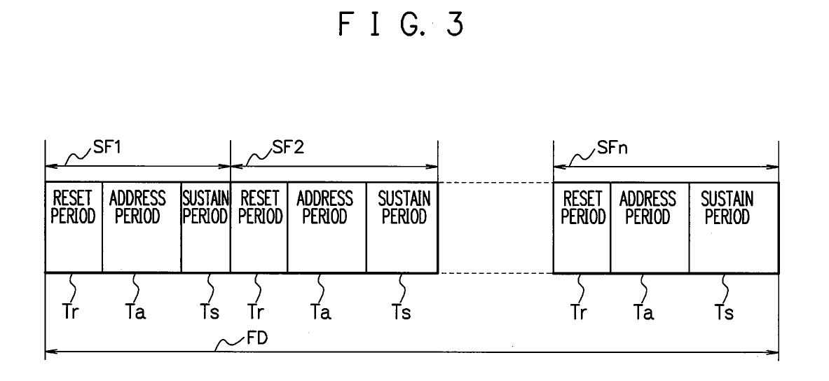

FIG. 3 is a diagram showing a configuration of one field FD of an image. The image is formed of, for example, 60 fields/sec. The one field FD is composed of a first subfield SF1, a second subfield SF2, . . . , and an n-th subfield SFn. This n is, for example, 10 and corresponds to the number of gradation bits. Each of the subfields SF1, SF2 and so on or their generic name is hereinafter referred to as a subfield SF.

Each subfield SF is composed of a reset period Tr, an address period Ta, and a sustain (sustain discharge) period Ts. In the reset period Tr, initialization of the display cell is performed. In the address period Ta, emission or non-emission of each display cell can be selected by address discharge between the address electrode Aj and the Y electrode Yi. In the sustain period Ts, the sustain discharge is performed between the X electrode Xi and the Y electrode Yi of the selected display cell to perform light emission. In each subfield SF, the number of light emissions (the length of the sustain period Ts) corresponding to the number of sustain pulses between the X electrode Xi and the Y electrode Yi is different. This enables determination of the gradation value.

The configuration in FIG. 1 will be described. The plasma display panel 124 can perform gradation expression of an image by selecting a pattern of subfields to be lit up from among a plurality of weighted subfields constituting one field.

An inverse gamma conversion processing circuit 101 receives a digital format image signal S1, applies an inverse gamma conversion to it, and outputs an image signal S2 with a linear characteristic.

A linear gain circuit 102 linearly converts the image signal S2 to an image signal S3 to express the image signal S3 by an integer part (real part) and a decimal part (error part). The image signal S3 has a less number of gradations than that of the image signal S2.

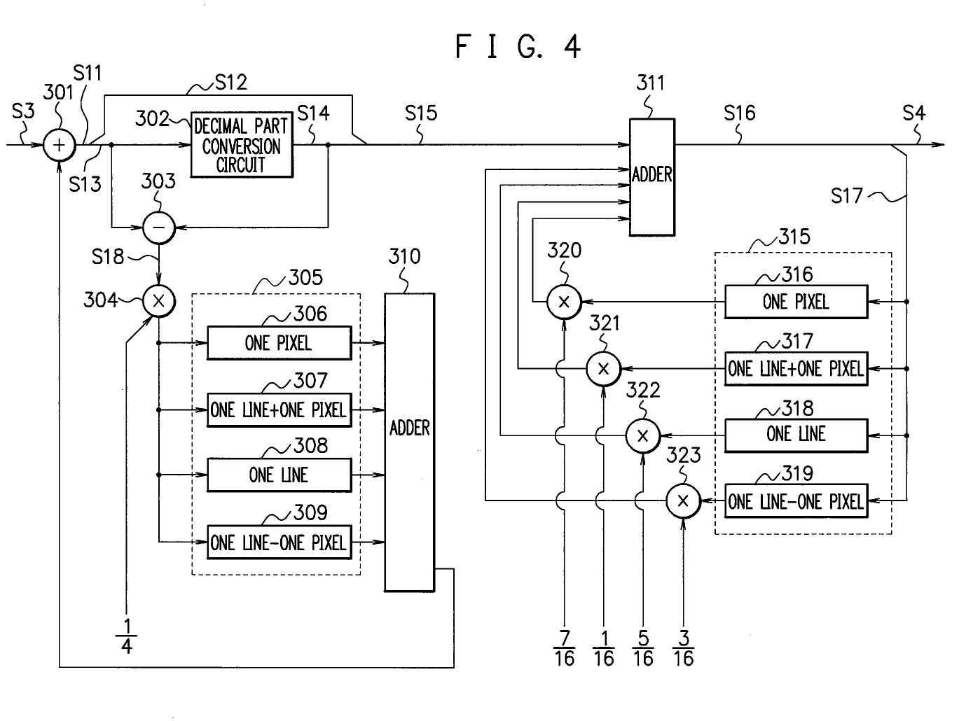

An error diffusion circuit 103 receives the input signal S3, and when the decimal part of the image signal S3 is not zero, the error diffusion circuit 103 diffuses this decimal part spatially and outputs an image signal S4 to perform a gradation expression in a false manner. The image signal S4 is a signal composed of only the integer part. The details of the error diffusion circuit 103 will be described later with reference to FIG. 4.

A subfield conversion circuit 104 selects a subfield lighting pattern based on the image signal S4 which has been subjected to error diffusion and generates a subfield lighting pattern signal S5. The address control circuit 121 generates a voltage for the address electrode Aj to select a subfield to be lit up regarding each pixel according to the subfield lighting pattern signal S5.

An every-subfield display load factor detection circuit 105 calculates a display load factor T2 for every subfield based on the subfield lighting pattern signal S5. The display load factor T2 is detected based on the number of light-emitting pixels and the gradation values of the light-emitting pixels. For example, when all pixels of the image are displayed at a maximum gradation value, the display load factor is 100%. When all pixels of the image are displayed at a half of the maximum gradation value, the display load factor is 50%. Also when only pixels of one half (50%) of the image are displayed at the maximum gradation value, the display load factor is 50%.

A sustain pulse number setting circuit 106 receives a timing signal T1 and the display load factor T2, and calculates the total number of sustain pulses in one field by constant power control according to the display load factor of one field. In the constant power control, the total number of sustain pulses in one field is controlled according to the display load factor of one field. Irrespective of the display load factor, when the total number of sustain pulses in one field is fixed, the power increases with an increase in the display load factor, resulting in increased heat quantity. Hence, the sustain pulse number setting circuit 106 performs constant power control by making a calculation so as to decrease the total number of sustain pulses in one field when the display load factor of one field is large.

A sustain pulse signal generation circuit 107 divides the total number of sustain pulses so as to correspond to the weight ratio among the respective subfields and generates a sustain pulse signal for display. The X electrode control circuit 122 and the Y electrode control circuit 123 generate voltages for the X electrode Xi and the Y electrode Yi according to the sustain pulse signal. The display cell selected by the address electrode Aj is sustain-discharged between the X electrode Xi and the Y electrode Yi and emits light.

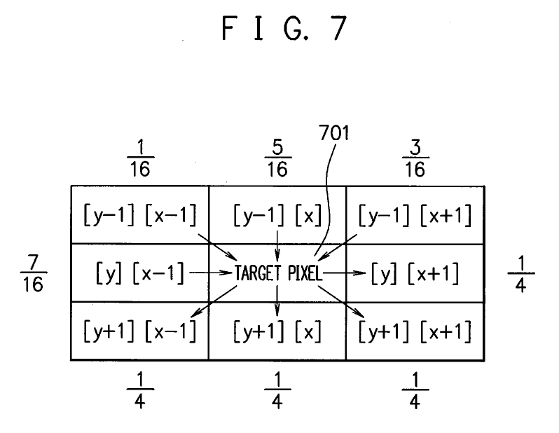

FIG. 7 is an illustration for explaining the error diffusion processing by the error diffusion circuit 103 in FIG. 1. Coordinates of a target pixel 701 are (x, y). Hereinafter, the coordinates (x, y) are expressed as coordinates [y] and [x]. A pixel at coordinates [y−1] and [x−1] is an upper-left adjacent pixel to the target pixel 701. A pixel at coordinates [y−1] and [x] is an upper adjacent pixel to the target pixel 701. A pixel at coordinates [y−1] and [x+1] is an upper-right adjacent pixel to the target pixel 701. A pixel at coordinates [y] and [x−1] is a left adjacent pixel to the target pixel 701. A pixel at coordinates [y] and [x+1] is a right adjacent pixel to the target pixel 701. A pixel at coordinates [y+1] and [x−1] is a lower-left adjacent pixel to the target pixel 701. A pixel at coordinates [y+1] and [x] is a lower adjacent pixel to the target pixel 701. A pixel at coordinates [y+1] and [x+1] is an lower-right adjacent pixel to the target pixel 701.

The error diffusion processing proceeds in the right direction from the pixel at the upper left end of the image, and upon reaching the pixel at the right end, the processing proceeds in the right direction from the pixel at the left end on a next lower line and is then similarly performed for next lower lines in sequence. Accordingly, when the processing is performed for the target pixel 701, the pixels at the coordinates [y−1] and [x−1], the coordinates [y−1] and [x], the coordinates [y−1] and [x+1], and the coordinates [y] and [x−1] are pixels which haven been already subjected to the error diffusion processing as the target pixel, whereas the pixels at the coordinates [y] and [x+1], the coordinates [y+1] and [x−1], the coordinates [y+1] and [x], and the coordinates [y+1] and [x+1] are pixels which will be later subjected to the error diffusion processing as the target pixel.

Next, the error diffusion method will be described. The error diffusion circuit 103 in FIG. 1 receives the image signal S3 composed of the integer part and the decimal part, and outputs the image signal S4 composed of the integer part. Since the image signal S4 is composed of the integer part, its error part (decimal part) is diffused to the adjacent pixels.

A case where the error diffusion processing is performed on the target pixel 701 will be described. To the image signal S3 for the target pixel 701, the decimal part of the pixel signal at the coordinates [y−1] and [x−1] is multiplied by an error diffusion coefficient of 1/16 to be weighted and then added, the decimal part of the pixel signal at the coordinates [y−1] and [x] is multiplied by an error diffusion coefficient of 5/16 to be weighted and then added, the decimal part of the pixel signal at the coordinates [y−1] and [x+1] is multiplied by an error diffusion coefficient of 3/16 to be weighted and then added, and the decimal part of the pixel signal at the coordinates [y] and [x−1] is multiplied by an error diffusion coefficient of 7/16 to be weighted and then added. The integer part of the addition result is outputted as the pixel signal S4 for the target pixel 701. The decimal part of the addition result is used when the pixels adjacent to the target pixel 701 are subjected to the error diffusion processing as the target pixel. The ratios of the above-described four error diffusion coefficients of 1/16, 5/16, 3/16, and 7/16 total up to 1.

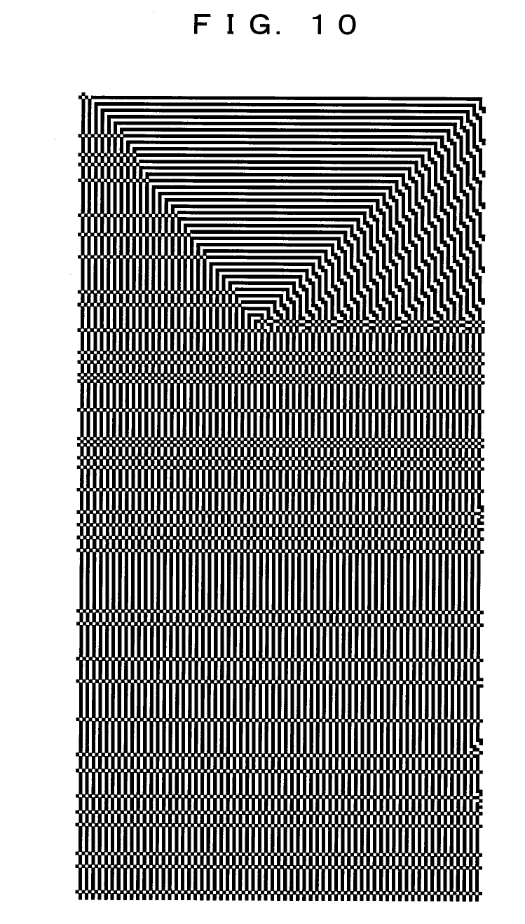

FIG. 10 is a view showing a figure pattern occurring in the image when the above-described error diffusion processing is performed on a flat portion of the image having the same gradation value. The figure pattern occurs at specific gradation values, and as a result of an experiment, it has been found that the figure pattern occurs when the decimal part of the image signal S3 inputted into the error diffusion circuit 103 takes a specific value.

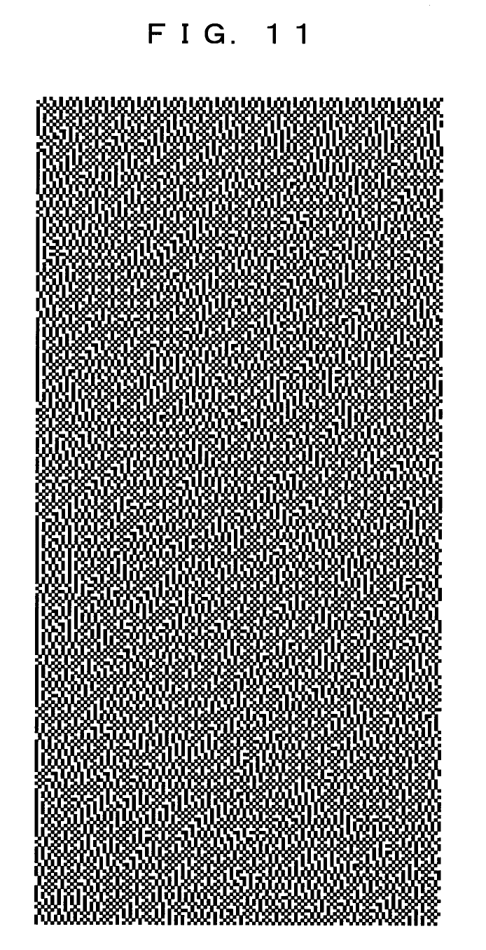

Note that the image is expressed by two values of white and black for clarification of illustration in FIG. 10, and the two values indicate a gradation value n and a gradation value n+1, having a difference therebetween of 1. This also applies to FIG. 11.

As an example, in the case where the entire screen is at a specific same input gradation value and the output value after the error diffusion is expressed by the gradation value n and the gradation value n+1, if the addition value of the decimal part of each pixel on a leading (uppermost) horizontal line and a result obtained by multiplying the error part (decimal part) of the left adjacent pixel by a predetermined error diffusion coefficient (for example, 7/16) is a decimal fraction less than one and close to one, carry is never produced in any pixel on the leading line, so that all of the pixels on the leading line take the gradation value n.

On the other hand, a pixel on a next (a next lower) horizontal line takes an addition value of the decimal part of each pixel on the horizontal line and results by multiplying the error part of the upper-left adjacent pixel, the error part of the upper adjacent pixel, and the error part of the upper-right adjacent pixel as well as the error part (decimal part) of the left adjacent pixel, by the respective predetermined error diffusion coefficients, so that carry is successively produced in each pixel on this horizontal line, and all of the pixels on the this horizontal line therefore take the gradation value n+1. Hereinafter, one of the gradation values can successively line up on every line, resulting in generation of a figure pattern.

In this embodiment, the possible value as the decimal part of the image signal S3 inputted into the error diffusion circuit 103 is limited, that is, the decimal part which possibly successively takes one of the gradation values as described above is detected and converted into another decimal value, to thereby prevent display in which only one of the gradation values successively lines up, and the error made by converting the decimal part of the input signal S3 is distributed at specific ratios to the adjacent pixels to reproduce the original image signal S3 without damage so as to prevent occurrence of the figure pattern.

For example, the error caused by converting the decimal part of the image signal S3 for the target pixel 701 is distributed at a ratio of ¼ and added to the signal for the adjacent pixel at the coordinates [y] and [x+1], distributed at a ratio of ¼ and added to the signal for the adjacent pixel at the coordinates [y+1] and [x−1], distributed at a ratio of ¼ and added to the signal for the adjacent pixel at the coordinates [y+1] and [x], and distributed at a ratio of ¼ and added to the signal for the adjacent pixel at the coordinates [y+1] and [x+1]. The ratios of the above-described four ratios of ¼ total up to 1. The above-described conversion error is evenly distributed and added to signals to a plurality of pixels adjacent to the target pixel.

Note that the above-describe four ratios may be made the same ratios of the above-described four error diffusion coefficients of 1/16, 5/16, 3/16, and 7/16. In this case, the distribution ratio to the right adjacent pixel at the coordinates [y] and [x+1] is 7/16, the distribution ratio to the lower-left adjacent pixel at the coordinates [y+1] and [x−1] is 3/16, the distribution ratio to the lower adjacent pixel at the coordinates [y+1] and [x] is 5/16, and the distribution ratio to the lower-right adjacent pixel at the coordinates [y+1] and [x+1] is 1/16.

FIG. 11 is a view, corresponding to FIG. 10, showing an image when the above-described error diffusion processing according to this embodiment has been performed on the flat portion of the image having the same gradation value. When the decimal part of the pixel signal S3 takes a specific value, carry can be produced by converting the value into another value, so that the gradation value n and the gradation value n+1 can be mixed on a random basis to prevent the figure pattern.

The phenomenon that a certain region at the upper left corner of the screen is displayed at only one of the gradations occurs because carry by the error diffusion processing is not produced over a plurality of pixels when the decimal part of the input signal at the specific gradation is close to zero. Hence, if it is detected that the decimal part of the input signal for the pixel in the certain region at the upper-left corner of the screen is close to zero, the decimal part is converted into a decimal part close to one so that carry is forcibly produced, whereby the phenomenon can be solved.

FIG. 4 is a block diagram showing a configuration example of the error diffusion circuit 103 in FIG. 1. The image signal S3 is a pixel signal for the target pixel 701 of 16 bits in total having, for example, the integer part of upper 8 bits and the decimal part of lower 8 bits. An error addition unit 301 adds the pixel signal S3 and an output signal of an adder 310 and outputs a pixel signal S11. The pixel signal S11 is a signal of 16 bits in total having the integer part of upper 8 bits and the decimal part of lower 8 bits similar to the pixel signal S3.

The pixel signal S11 is separated into an integer part pixel signal S12 and a decimal part pixel signal S13. The integer part pixel signal S12 is a signal of the integer part of upper 8 bits of the pixel signal S11. The decimal part pixel signal S13 is a signal of the decimal part of lower 8 bits of the pixel signal S11.

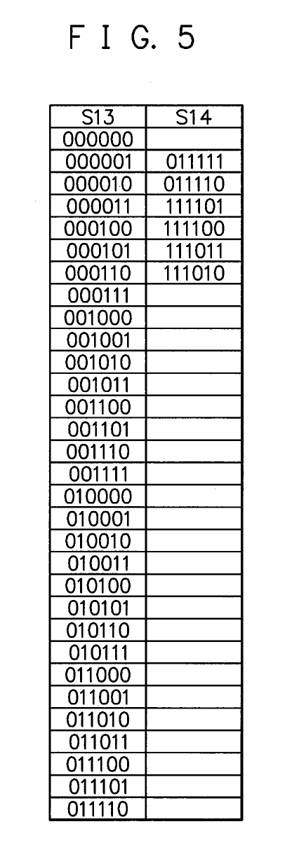

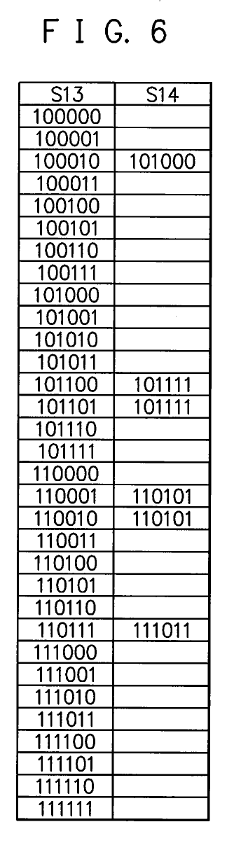

A decimal part conversion circuit 302 converts the value of the decimal part pixel signal S13 into another value when the decimal part pixel signal S13 takes a specific value, and outputs the converted value as a decimal part pixel signal S14, whereas outputs the value of the decimal part pixel signal S13 as it is as a decimal part pixel signal S14 when the decimal part pixel signal S13 does not take a specific value. The details of the decimal part conversion circuit 302 will be described later with reference to FIG. 5 and FIG. 6.

A subtractor 303 subtracts the decimal part pixel signal S14 after conversion from the decimal part pixel signal S13 before conversion, and outputs a decimal part pixel signal S18. The decimal part pixel signal S18 is a signal representing the difference between the decimal part pixel signal S14 and the decimal part pixel signal S13. A multiplier 304 multiplies the decimal part pixel signal S18 by a coefficient of ¼ and outputs the result to delay circuits 306 to 309.

A delay circuit 305 has the delay circuits 306 to 309. The delay circuit 306 is a delay circuit for adding the conversion error of the target pixel 701 in FIG. 7 to the signal for the right adjacent pixel at the coordinates [y] and [x+1], and outputs an output signal of the multiplier 304 after delaying it by one pixel clock. The delay circuit 307 is a delay circuit for adding the conversion error of the target pixel 701 in FIG. 7 to the signal for the lower-right adjacent pixel at the coordinates [y+1] and [x+1], and outputs the output signal of the multiplier 304 after delaying it by one line+one pixel clock. The delay circuit 308 is a delay circuit for adding the conversion error of the target pixel 701 in FIG. 7 to the signal for the lower adjacent pixel at the coordinates [y+1] and [x], and outputs the output signal of the multiplier 304 after delaying it by one line. The delay circuit 309 is a delay circuit for adding the conversion error of the target pixel 701 in FIG. 7 to the signal for the lower-left adjacent pixel at the coordinates [y+1] and [x−1], and outputs the output signal of the multiplier 304 after delaying it by one line−one pixel clock.

The adder 310 adds the output signals of the delay circuits 306 to 309 and outputs a result to the error addition unit 301. The error addition unit 301 adds the pixel signal S3 and the output signal of the adder 310 and thereby can distribute and add the error pixel signal S18 for the target pixel to the signals for the adjacent pixels to the target pixel. In other words, the error addition unit 301 adds, to the pixel signal S3 for the target pixel, the error part pixel signal S18 of the adjacent pixel thereto. This can diffuse the error caused by the conversion by the decimal part conversion circuit 302 to the signals for the adjacent pixels to faithfully reproduce the original image signal S3 to thereby express it in false gradations.

A pixel signal S15 is a signal composed of the integer part pixel signal S12 and the decimal part pixel signal S14. More specifically, the pixel signal S15 is a pixel signal of 16 bits in total having the integer part pixel signal S12 as an integer part of upper 8 bits and the decimal part pixel signal S14 as a decimal part of lower 8 bits.

An adder 311 adds the pixel signal S15 and output signals of multipliers 320 to 323 and outputs a pixel signal S16. The multipliers 320 to 323 output a decimal part pixel signal of 8 bits. The pixel signal S16 is a pixel signal of 16 bits in total having an integer part of upper 8 bits and a decimal part of lower 8 bits.

The pixel signal S16 is separated into an integer part pixel signal S4 and a decimal part pixel signal S17. The integer part pixel signal S4 is a signal of the integer part of upper 8 bits of the pixel signal S16 and is a target pixel output signal of the error diffusion circuit 103. The decimal part pixel signal S17 is a signal of the decimal part of lower 8 bits of the pixel signal S16.

A delay circuit 315 has delay circuits 316 to 319. The delay circuit 316 is a delay circuit for adding the decimal part pixel signal of the left adjacent pixel at the coordinates [y] and [x−1] in FIG. 7 to the signal for the target pixel 701, and outputs the decimal part pixel signal S17 after delaying it by one pixel clock. The delay circuit 317 is a delay circuit for adding the decimal part pixel signal of the upper-left adjacent pixel at the coordinates [y−1] and [x−1] in FIG. 7 to the signal for the target pixel 701, and outputs the decimal part pixel signal S17 after delaying it by one line+one pixel clock. The delay circuit 318 is a delay circuit for adding the decimal part pixel signal of the upper adjacent pixel at the coordinates [y−1] and [x] in FIG. 7 to the signal for the target pixel 701, and outputs the decimal part pixel signal S17 after delaying it by one line. The delay circuit 319 is a delay circuit for adding the decimal part pixel signal of the upper-right adjacent pixel at the coordinates [y−1] and [x+1] in FIG. 7 to the signal for the target pixel 701, and outputs the decimal part pixel signal S17 after delaying it by one line−one pixel clock.

The multiplier 320 multiplies the output signal of the delay circuit 316 by an error diffusion coefficient of 7/16 and outputs the result to the adder 311. A multiplier 321 multiplies the output signal of the delay circuit 317 by an error diffusion coefficient of 1/16 and outputs the result to the adder 311. A multiplier 322 multiplies the output signal of the delay circuit 318 by an error diffusion coefficient of 5/16 and outputs the result to the adder 311. A multiplier 323 multiplies the output signal of the delay circuit 319 by an error diffusion coefficient of 3/16 and outputs the result to the adder 311. The output signal of the multipliers 320 to 322 is the decimal part pixel signal of 8 bits.

The adder 311 adds the pixel signal S15 and the output signals of the multipliers 320 to 322 and outputs the pixel signal S16. In FIG. 11, the gradation value becomes n if carry to the integer part is not produced in the adder 311, whereas the gradation value becomes n+1 if carry is produced. The output pixel signal S4 of the target pixel is a signal of the integer part of the pixel signal S16. The decimal part of the pixel signal S16 is added to the pixel signals for the adjacent pixels as the decimal part pixel signal S17 in the adder 311. This can diffuse the error caused by converting the output pixel signal S4 into only the integer part of the pixel signal S16, to the signals for the adjacent pixels to faithfully reproduce the original image signal S3 to thereby express it in false gradations.

FIG. 5 and FIG. 6 are diagrams showing examples where the decimal part conversion circuit 302 converts the decimal part pixel signal S13 into the decimal part pixel signal S14. The decimal part pixel signal S13 and the decimal part pixel signal S14 are shown by binary expression here. For simplification of explanation, a case where each of the decimal part pixel signals S13 and S14 are composed of 6 bits will be described. Blank portions for the pixel signal S14 represent that the pixel signal S13 is outputted as the pixel signal S14 as it is.

“000001”, “000010”, “000011”, “000100”, “000101” and “000110” in FIG. 5 are specific values of the pixel signal S13. The specific values in FIG. 5 are close to zero, and if the entire screen is displayed only by such same gradation value, carry by the error diffusion processing is hardly produced. Therefore, carry is not produced at all in the upper-left corner region so that carry becomes nonuniform, leading to failure to correctly express the gradations. In this embodiment, carry is made uniform by forcibly producing carry in the aforementioned region. If the pixel signal S13 takes a specific value in FIG. 5, the decimal part conversion circuit 302 converts it into another value and outputs the pixel signal s14. More specifically, when the decimal part pixel signal S13 for the target pixel takes a value equal to or smaller than a first value (for example, “000110”), the decimal part conversion circuit 302 converts the decimal part pixel signal S13 into a value larger than the first value (for example, “000110”).

“100010”, “101100”, “101101”, “110001”, “110010” and “110111” in FIG. 6 are specific values of the pixel signal S13. The specific values in FIG. 6 are the pixel signals S13 which are likely to cause the figure pattern, and are apt to cause the figure pattern especially when the pixel signal S13 is slightly different from ½, ⅔, and ¾. In the example of FIG. 6, the figure pattern occurs at “100010” as a value close to ½, at “101100” and “101101” as values close to ⅔, and at “110001” and “110010” as values close to ¾. In FIG. 6, the pixel signal S13 is converted into “101000” that is a numerical value between ½ and ⅔ when the pixel signal S13 is “100010”, converted into “101111” that is a numerical value between ⅔ and ¾ when the pixel signal S13 is “101100” and “101101”, and converted into “110101” that is a value larger than ¾ when the pixel signal S13 is “110001” and “110010”. This can prevent occurrence of noise in the figure pattern as shown in FIG. 11.

In the decimal part conversion circuit 302, the kinds of the value of the decimal part conversion signal S14 after conversion are smaller in number than the kinds of the value of the decimal part pixel signal S13 before conversion. Note that the decimal part conversion circuit 302 may convert the decimal part pixel signal S13 to another value by discarding specific lower bits and output the decimal part pixel signal S14.

### Second Embodiment

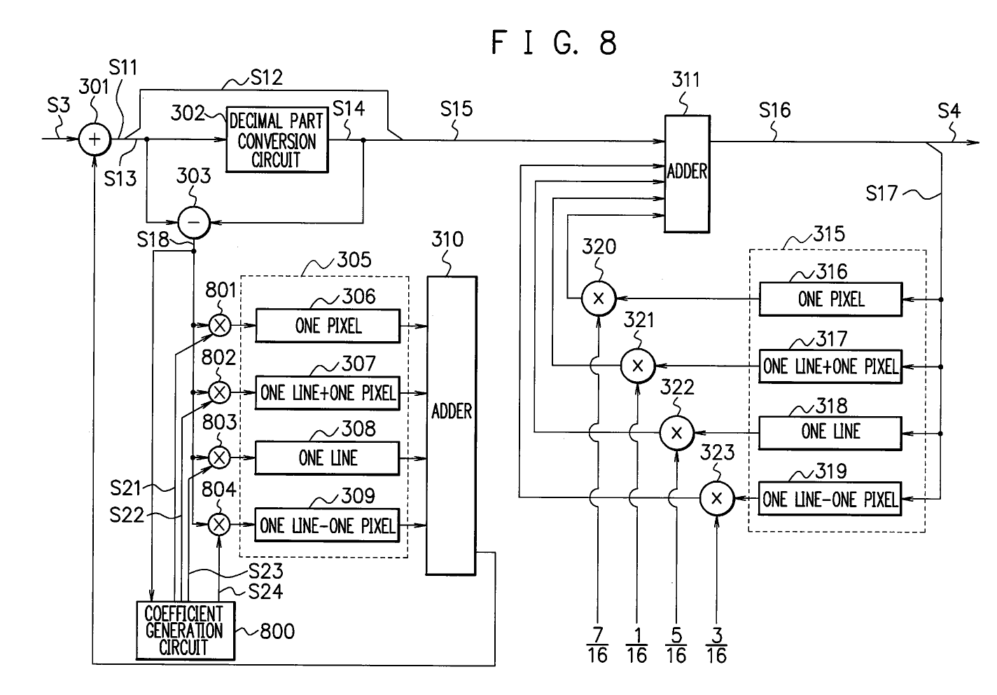

FIG. 8 is a block diagram showing a configuration example of the error diffusion circuit 103 (FIG. 1) according to a second embodiment of the present invention. This embodiment (FIG. 8) is made by removing the adder 304 and adding a coefficient generation circuit 800 and multipliers 801 to 804 from/to the first embodiment (FIG. 4). Hereinafter, points of this embodiment different from the first embodiment will be described.

The coefficient generation circuit 800 generates coefficients S21 to S24 according to the decimal part pixel signal S18. The multiplier 801 multiplies the decimal part pixel signal S18 by the coefficient S21 and outputs the result to the delay circuit 306. The multiplier 802 multiplies the decimal part pixel signal S18 by the coefficient S22 and outputs the result to the delay circuit 307. The multiplier 803 multiplies the decimal part pixel signal S18 by the coefficient S23 and outputs the result to the delay circuit 308. The multiplier 804 multiplies the decimal part pixel signal S18 by the coefficient S24 and outputs the result to the delay circuit 309.

In the first embodiment, the pixel signal S18 is multiplied by the coefficient of ¼ and the result is outputted to the delay circuits 306 to 309. However, there is a case where the value of the pixel signal S18 cannot be divided by 4. In this case, the whole value of the pixel signal S18 cannot be divided and added to the signals for the adjacent pixels.

In this embodiment, the coefficients S21 to S24 is variably controlled according to the pixel signal S18, whereby the whole value of the pixel signal S18 can be divided and added to the signals for the adjacent pixels, so that more accurate gradation expression can be performed.

For example, the coefficient generation circuit 800 generates the coefficients S22 to S24 as described below. When the pixel signal S18 is “00000001” (binary expression), the coefficient S21 is set to 1 and the coefficients S22 to S24 are set to 0. When the pixel signal S18 is “00000010” (binary expression), the coefficients S21 and S23 are set to 1 and the coefficients S22 and S24 are set to 0. When the pixel signal S18 is “00000011” (binary expression), the coefficients S21 to S23 are set to 1 and the coefficient S24 is set to 0. When the pixel signal S18 is “00000100” (binary expression), the coefficients S21 to S24 are set to 1.

AS described above, according to this embodiment, the error addition unit 301 distributes and adds the difference between the decimal part pixel signal S13 before conversion and the decimal part pixel signal S14 after conversion to a plurality of pixels adjacent to the target pixel at ratios according to the difference.

### Third Embodiment

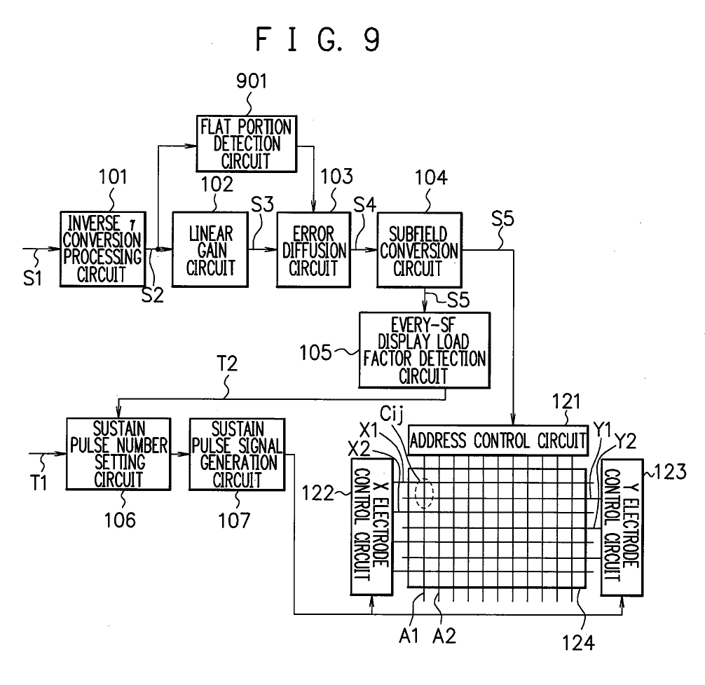

FIG. 9 is a diagram showing a configuration example of a plasma display device (a display device) according to a third embodiment of the present invention. This embodiment (FIG. 9) is made by adding a flat portion detection circuit 901 to the first embodiment (FIG. 1).

The flat portion detection circuit 901 detects whether or not a plurality of pixels adjacent to the target pixel and the target pixel constitute an image flat portion. More specifically, the flat portion detection circuit 901 detects whether or not the integer parts of the pixel signals S2 for the plurality of pixels adjacent to the target pixel and for the target pixel are identical, and thereby detects that the plurality of pixels adjacent to the target pixel and the target pixel constitute the image flat portion, when the integer parts are identical. Note that the flat portion detection circuit 901 may detect whether or not the integer parts of the pixel signals S3, in place of the pixel signals S2, for the plurality of pixels adjacent to the target pixel and for the target pixel are identical, and thereby detects that the plurality of pixels adjacent to the target pixel and the target pixel constitute the image flat portion, when the integer parts are identical.

When it is not detected that the plurality of pixels adjacent to the target pixel and the target pixel constitute the image flat portion, the decimal part conversion circuit 302 in the error diffusion circuit 103 does not perform conversion so that the pixel signal S13 becomes the pixel signal S14 as it is. The decimal part conversion circuit 302 in the error diffusion circuit 103 performs conversion only when it is detected that the plurality of pixels adjacent to the target pixel and the target pixel constitute the image flat portion.

If the normal error diffusion processing is performed on the image within the image flat portion, the noise in the figure pattern will occur as shown in FIG. 10. In contrast, no noise in the figure pattern occurs even if the normal error diffusion processing is performed on the image without the image flat portion.

In this embodiment, the error diffusion processing in the above embodiment for preventing occurrence of noise in the figure pattern is performed only when it is detected that the plurality of pixels adjacent to the target pixel and the target pixel constitute the image flat portion, whereas the normal error diffusion processing is performed when it is not detected that the plurality of pixels adjacent to the target pixel and the target pixel constitute the image flat portion.

Note that examples of the plasma display device have been described in the first to third embodiments, but the present invention is not limited to them but is also applicable to other display deices.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

### INDUSTRIAL APPLICABILITY

The noise in the figure pattern occurring due to error diffusion can be suppressed to improve the image quality.

What is claimed is:

1. A display device comprising:
a decimal part conversion unit which converts a value of a decimal part of a pixel signal for a target pixel into another value when the decimal part takes a specific value, the pixel signal having an integer part and the decimal part;
an error addition unit which distributes and adds a difference between the decimal part before the conversion and the decimal part after the conversion to signals for a plurality of pixels adjacent to the target pixel; and
an error diffusion unit which performs addition based on a pixel signal for the target pixel composed of the decimal part after the conversion and the integer part and decimal parts of the signals for the plurality of pixels adjacent to the target pixel, and outputs an integer part after the addition as a pixel signal for the target pixel.

2. The display device according to claim 1,
wherein said error addition unit distributes and adds the difference between the decimal part before the conversion and the decimal part after the conversion to the signals for the plurality of pixels adjacent to the target pixel at specific ratios, and
wherein said error diffusion unit weights and adds the decimal parts of the signals for the plurality of pixels adjacent to the target pixel.

3. The display device according to claim 1,
wherein the plurality of pixels adjacent to the target pixel in said error addition unit are pixels to be processed later as target pixels, and
wherein the plurality of pixels adjacent to the target pixel in said error diffusion unit are pixels which have already been processed as target pixels.

4. The display device according to claim 1,
wherein the plurality of pixels adjacent to the target pixel in said error addition unit include a lower adjacent pixel and a right adjacent pixel to the target pixel, and
wherein the plurality of pixels adjacent to the target pixel in said error diffusion unit include an upper adjacent pixel and a left adjacent pixel to the target pixel.

5. The display device according to claim 1,
wherein said decimal part conversion unit converts the value of the decimal part into the other value by discarding specific lower bits of the decimal part.

6. The display device according to claim 1,
wherein kinds of the value of the decimal part after the conversion are smaller in number than kinds of the value of the decimal part before the conversion.

7. The display device according to claim 1,
wherein said error addition unit evenly distributes and adds the difference between the decimal part before the conversion and the decimal part after the conversion to the signals for the plurality of pixels adjacent to the target pixel.

8. The display device according to claim 2,
wherein the specific ratios in said error addition unit and ratios of the weighting in said error diffusion unit are the same.

9. The display device according to claim 1, further comprising:
an image flat portion detection unit which detects whether or not the plurality of pixels adjacent to the target pixel and the target pixel constitute an image flat portion,
wherein said decimal part conversion unit performs the conversion only when it is detected that the plurality of pixels adjacent to the target pixel and the target pixel constitute the image flat portion.

10. The display device according to claim 1, further comprising:
a detection unit which detects whether or not the integer parts of the pixel signals for the plurality of pixels adjacent to the target pixel and for the target pixel are identical,
wherein said decimal part conversion unit performs the conversion only when it is detected that the integer parts are identical.

11. The display device according to claim 1,
wherein when the decimal part of the pixel signal for the target pixel is equal to or smaller than a first value, said decimal part conversion unit converts the decimal part into a value larger than the first value.

12. The display device according to claim 1,
wherein said error addition unit distributes and adds the difference between the decimal part before the conversion and the decimal part after the conversion to the signals for the plurality of pixels adjacent to the target pixel at specific ratios totaling up to 1.

13. The display device according to claim 1,
wherein said error addition unit distributes and adds the difference between the decimal part before the conversion and the decimal part after the conversion to the signals for the plurality of pixels adjacent to the target pixel at specific ratios according to the difference.

14. The display device according to claim 1,
wherein when the decimal part of the pixel signal for the target pixel does not take the specific value, said error diffusion unit adds the integer part and the decimal part of the pixel signal for the target pixel and the decimal parts of the signals for the plurality of pixels adjacent to the target pixel, and outputs an integer part after the addition as a pixel signal for the target pixel.

15. The display device according to claim 1, further comprising:
a plasma display panel which performs display based on the pixel signal outputted by said error diffusion unit.

16. An error diffusion method for a display device, comprising:
a decimal part conversion step of converting a value of a decimal part of a pixel signal for a target pixel into another value when the decimal part takes a specific value, the pixel signal having an integer part and the decimal part;
an error addition step of distributing and adding a difference between the decimal part before the conversion and the decimal part after the conversion to signals for a plurality of pixels adjacent to the target pixel; and
an error diffusion step of performing addition based on a pixel signal for the target pixel composed of the decimal part after the conversion and the integer part and decimal parts of the signals for the plurality of pixels adjacent to the target pixel, and outputting an integer part after the addition as a pixel signal for the target pixel.
